(19) United States
(12) Patent Application Publication
(10) Pub. No.: US 2026/0225954 A1
(43) Pub. Date: Aug. 6, 2026

(54) LOW-CARBON CONSTRUCTION BINDER AND ASSOCIATED CONSTRUCTION MATERIAL

(71) Applicant: MATERRUP, SAINT-GEOURS-DE-MAREMNE (FR)

(72) Inventors: Mathieu NEUVILLE, SAINT-GEOURS-DE-MAREMNE (FR); Manuel MERCÉ, Saint Vincent de Tyrosse (FR); Julie KRAMMER DEVILLARD, SAINT-GEOURS-DE-MAREMNE (FR); Vincent TRINCAL, SAINT-GEOURS-DE-MAREMNE (FR)

(21) Appl. No.: 19/142,362

(22) PCT Filed: Dec. 21, 2023
(86) PCT No.: PCT/EP2023/087506

§ 371 Date: Aug. 18, 2025

(30) Foreign Application Priority Data
Dec. 23, 2022 (FR) FR2214479

(51) Int. Cl. C04B 28/02; C04B 14/10; C04B 14/28; C04B 40/00; C04B 111/00

(52) U.S. Cl. CPC C04B 28/02; C04B 14/10; C04B 14/28; C04B 40/0042; C04B 2111/00017; C04B 2201/50

(57) ABSTRACT

The invention relates to a construction binder comprising:
from 35% to 65% by weight of clinker,
from 5% to 30% by weight of a calcined clay matrix,
from 5% to 30% by weight of a raw clay matrix, and
from 0.05% to 5% by weight of a deflocculation agent;
   and the mass ratio of raw clay matrix to calcined clay matrix is from 0.2 to 7.

The invention further relates to a construction material comprising a construction binder according to the invention.

### TECHNICAL FIELD

The invention relates to the field of construction and more particularly to that of low-carbon construction materials. In particular, it relates to a low-carbon construction binder including a raw clay matrix and a calcined clay matrix. Furthermore, the invention relates to a construction material produced from a construction binder according to the invention.

### PRIOR ART

The known prior art from which the invention was developed is described below.

Cement is the second most consumed p in the world, with more than 4 billion tons produced annually worldwide. This consumption is constantly increasing, driven by the growing demand for housing and infrastructure. Cement is particularly used for the manufacture of masonry units that rely on cementitious materials as binders. Due to the constant development of new infrastructure in most countries around the world, there is a constant demand for the supply of construction binders, more specifically mineral resources for the formation of cements, especially Portland cements. However, the production and use of Portland cement is associated with a high environmental footprint. The cement used in the construction field is generally Portland cement. It is a hydraulic binder that, when mixed with water, hardens and sets. After hardening, the cement retains its strength and stability even when exposed to water. There is a wide variety of cements used worldwide. However, all conventional cements include clinker at a percentage ranging from 5% for some blast furnace cements to a minimum of 95% for Portland cement, which is the most widely used cement in the world today. Clinker is produced by firing a mixture of approximately 80% limestone and 20% aluminosilicates (such as clays). This firing, known as clinkerization, is generally carried out at a temperature of over 1200° C., therefore such a cement preparation process involves high energy consumption. In addition, the chemical conversion of limestone into lime also releases carbon dioxide. As a result, the cement industry generates approximately 8% of global CO₂ emissions.

Indeed, it is estimated that the manufacture of a Portland-type construction binder generates on average 0.8 kg of CO₂ per kg of Portland cement clinker produced. Various solutions have therefore been developed to attempt to at least partially replace certain components of the construction binders used for the formation of Portland-type cements. These solutions are primarily aimed at reducing the carbon footprint.

A first solution, described in document no EP3274315, relates to a composition for a building material allowing the use of readily available and reactive materials, and with a low ecological impact and not requiring long and costly heat treatment. To this end, the composition for a building material comprises a matrix mainly containing a compound based on a “flashed” metakaolin, that is to say obtained by rapid calcination of a powdered clay at a temperature comprised between 600° C. and 900° C. for a few seconds, followed by rapid cooling, and an alkaline activation solution. This composition further comprises a mass proportion of cement or clinker of less than 10%, while the alkaline activation solution comprises a source of sodium or potassium silicate and an alkaline base. The relative proportions of the activation solution and the matrix being such that the total sum in moles of sodium silicate and alkali base of the activation solution is comprised between 3.5 and 5.5 mol/kg of matrix and the alkaline activation solution has an overall molar ratio of sodium silicate to alkali base comprised between 1.25 and 1.65.

A second solution, described in document no WO2010130511, proposes a construction material comprising at least 65% by weight of Portland cement clinker, a calcined clay produced at a temperature between 500° C. and 900° C. and a carbonate ground to a specific surface area of 3000-15000 cm²/g in which the weight ratio of the calcined clay material to the carbonate material is comprised between 0.25 and 3. This construction material allows to maintain high mechanical strength, compared to Portland-type cement, and to reduce CO₂ emissions during cement production.

Although these solutions allow the production of building materials that have mechanical strengths similar to those of Portland cement, such as Portland cement type CEM1 or CEM2, the composition of the construction binders, at the origin of these building materials, still requires too large quantities of calcined components, such as calcined clays and/or Portland cement clinker. Thus, the carbon footprint of these building materials can still be improved. However, the main difficulties lie in maintaining a mechanical compressive strength, at an early age (at 1 day) but also at 28 days, a rheology close to that of Portland cement type CEM 2 while reducing the carbon footprint of the building material produced.

The invention aims at overcoming the disadvantages of the prior art. In particular, the invention aims at proposing a low-carbon construction binder having an improved carbon footprint and an improved energy balance compared to the construction binders of the prior art, while ensuring compressive strength and rheology close to those of Portland cement of type CEM 2.

The invention further aims at proposing a low-carbon construction material manufactured from a construction binder according to the invention, said construction material having a compressive strength at least equivalent to that of Portland cement, an improved carbon and energy footprint compared to the construction materials of the prior art.

### SUMMARY OF THE INVENTION

The invention aims at overcoming these disadvantages.

The invention relates in particular to a construction binder comprising
from 35% to 65% by weight of clinker,
from 5% to 30% by weight of a calcined clay matrix,
from 5% to 30% by weight of a raw clay matrix, and
from 0.05% to 5% by weight of a deflocculation agent;
   and in that the mass ratio of the raw clay matrix to the calcined clay matrix is from 0.2 to 7.

The combination of raw clay and partially substituted calcined clay allows to reduce the carbon footprint compared to a conventional LC3 type construction binder firstly by limiting the content of calcined constituents, such as CEM 1 type cement or calcined clay matrix, required and by reducing the energy input required for the formation of a construction material. Furthermore, a construction binder according to the invention also ensures the maintenance of a young-age compressive strength greater than 5 MPa as well as an improvement in the rheology of the construction binder in the fresh state.

According to other optional features, the construction binder according to the invention may include the following features taken alone or in combination:
Up to 25% by weight of a precursor.
The precursor comprises a source of calcium carbonate.
The precursor is selected from: blast furnace slag, fly ash, silica fumes, natural or synthetic limestone filler, siliceous filler, diatomite.

Calcium carbonate has a D50 comprised between 0.1 microns and 5 microns.
Calcium carbonate comprises vaterite.
The deflocculation agent is an organic deflocculation agent.
The clay matrix has a D50 approximately equal to 10 μm.
35% by weight of clinker.
At most 65% by weight of clinker.
Between 35% and 50% by weight of clinker.
20% by weight of precursor.
Between 15% and 20% by weight of precursor.
5% by weight of calcined clay matrix.
At least 10% by weight of raw clay matrix.
At least 30% by weight of raw clay matrix.
The calcined clay matrix is a flashed clay matrix.
The calcined clay matrix is a natural pozzolanic rock.
The calcined clay matrix is metakaolin.
The construction binder comprises at least:
   from 40% to 55% by weight of clinker,
   up to 25% by weight of a precursor,
   from 5% to 15% by weight of a calcined clay matrix,
   from 15% to 30% by weight of a raw clay matrix, and
   from 0.05% to 2% by weight of a deflocculation agent;
      and in that the mass ratio of the raw clay matrix to the calcined clay matrix is from 0.5 to 6.
The construction binder comprises at least:
   39% by weight of clinker,
   20% by weight of a precursor,
   10% by weight of a calcined clay matrix,
   30% by weight of a raw clay matrix, and
   1% by weight of a deflocculation agent.
The construction binder comprises:
   39% by weight of clinker,
   20% by weight of a precursor,
   20% by weight of a calcined clay matrix,
   20% by weight of a raw clay matrix, and
   1% by weight of a deflocculation agent.

According to a second object, the invention further relates to a construction material comprising a construction binder according to the invention.

### DESCRIPTION OF THE EMBODIMENTS

Other characteristics and advantages of the invention will be better understood upon reading the description which follows and with reference to the appended drawings, given in an illustrative and non-limiting manner.

Below, a summary of the invention and the associated vocabulary are described, before presenting the disadvantages of the prior art, and finally showing in more detail how the invention overcomes them.

In the remainder of the description, the term “by weight” in relation to the construction binder, must be understood as being a proportion relative to the dry weight of the construction binder. The dry weight corresponds to the weight before the addition of water, for example, necessary for the formation of a construction material. When the values of % by weight are given in the form of intervals, the limits are included.

The expression “clay matrix”, within the meaning of the invention, may correspond to one or more rock materials based on phyllosilicates, hydrated silicates or aluminosilicates with a lamellar structure, said clay matrix being composed at least in part of fine particles generally originating from the alteration of silicates with a three-dimensional framework or from the precipitation of a supersaturated fluid. A clay matrix may thus include a mixture of such rock materials which may, for example, include kaolinite, serpentine, pyrophyllite, talc, smectite, vermiculite, illite, glauconite, mica, chlorite, palygorskite, sepiolite, interstratified materials or mixtures thereof (Alain Meunier. Clays, 2005). Furthermore, a clay matrix may include loams or silts. A clay matrix may come, without limitation, from construction site spoil, quarry fines, clay-limestone fines, wash fines, clay sludge, stripping materials, clayey excavation materials such as excavated earth, or sediments, including dredged sediments and varves, phyllosilicate rocks and alterites such as turbidites, marls, pelites, ruffes, laterites, schists, mica schists.

“Concrete” means a mixture of aggregates, possibly sand, with a construction binder (for example cement) and water, which has set. Thus, the term concrete can correspond to a construction element formed from a mixture of aggregates, mineral or vegetable, possibly including sand, one or more additives, construction binder and water.

The expression “raw clay matrix” corresponds, within the meaning of the invention, to a clay matrix that has not undergone a calcination step. In particular, that is to say that it has not undergone any prior heat treatment. For example, this corresponds to a clay matrix that has not undergone a temperature rise greater than 300° C., preferably greater than 200° C. and more preferably a temperature greater than 150° C. Indeed, the raw clay matrix may undergo a drying step requiring a temperature rise generally substantially equal to or less than 150° C. but no calcination step. A raw clay matrix may preferably comprise rock materials which may for example comprise kaolinite, serpentine, pyrophyllite, talc, smectite, vermiculite, illite, glauconite, mica, chlorite, palygorskite, sepiolite, interstratified rocks or mixtures thereof.

For the purposes of the invention, a “deflocculating agent”, “deflocculant” or “deflocculation agent”, can correspond to a compound capable of dissociating aggregates and colloids, particularly in aqueous suspension. Deflocculating agents have, for example, been used in the context of drilling or oil extraction to make clay more fluid and facilitate extraction or drilling.

The term “binder” or “construction binder” within the meaning of the invention can be understood as a formulation allowing to ensure the agglomeration of materials together, in particular during the setting, then the hardening of a construction material. Thus, it allows in particular to ensure the agglomeration of sand and other aggregates with the constituents of the binder. The binder according to the invention is in particular a hydraulic binder, that is to say that hardening takes place upon contact with water.

The term “Portland cement” refers to a hydraulic binder composed mainly of hydraulic calcium silicates whose setting and hardening is made possible by a chemical reaction with water. Portland cement generally contains at least 95% clinker and a maximum of 5% secondary constituents such as alkalis (Na₂O, K₂O), magnesia (MgO), gypsum (CaSO₄·2H₂O) or various traces of metals.

The expression “metal oxides” may refer, within the meaning of the invention, to a composition comprising metal oxides such as aluminates. In particular, a construction binder according to the invention may comprise a metal oxide composition comprising more than 25% by weight of metal oxides, preferably more than 30% by weight of metal oxides, more preferably more than 40% by weight of metal oxides and even more preferably more than 45% by weight of metal oxides. For example, the metal oxide composition includes more than 2% by weight of aluminate, preferably more than 5% by weight of aluminate, more preferably more than 7% by weight of aluminate and even more preferably more than 10% by weight of aluminate. In addition, the metal oxides may correspond to, or comprise, alkaline earth oxides. For example, the metal oxide composition may comprise more than 10% by weight of calcium oxide, preferably more than 20% by weight of calcium oxide, more preferably more than 25% by weight of calcium oxide and even more preferably more than 30% by dry weight of calcium oxide. The metal oxide composition may include chemical species which are not metal oxides. For example, the metal oxide composition may be replaced by aluminum or silicon oxides with, for example, more than 10% by weight of aluminum or silicon oxide, preferably more than 20% by weight of aluminum or silicon oxide, more preferably more than 25% by weight of aluminum or silicon oxide and even more preferably more than 30% by weight of aluminum or silicon oxide. These mass concentrations can be easily measured by the person skilled in the art using conventional techniques for measuring metal oxides or aluminum or silicon oxides. In particular, the expression “metal oxide composition” refers to a composition comprising more than 50%, preferably more than 70%, more preferably more than 80% and even more preferably more than 90% of metal oxides and/or aluminum or silicon oxides, including aluminates. Preferably, a metal oxide composition will correspond to a slag from metallurgy, such as a blast furnace slag or else fly ash. The “metal oxide” composition is preferably a calcined metal oxide composition. That is to say, it has undergone a high-temperature step. This high-temperature step may be natural or artificial; in this case, it is a high-temperature treatment. The high temperature step may for example correspond to a treatment at a temperature greater than or equal to 400° C., preferably greater than or equal to 750° C. and more preferably greater than or equal to 900° C.; and even more preferably greater than 1000° C. The metal oxide composition of a composition or of a construction element may be determined by X-ray fluorescence (“Standard Test Methods for Chemical Analysis of Hydraulic Cement” December 2022; ASTM C114-18 or according to standard EN ISO 29581-2:2010.

The term “substantially equal” within the meaning of the invention corresponds to a value varying by less than 20% relative to the compared value, preferably by less than 10%, even more preferably by less than 5%.

The term “clinker” or “Portland clinker” refers to a constituent of cement and comes from the firing of a mixture composed of approximately 80% limestone and 20% aluminosilicates (such as clays). This firing, clinkerization, is generally carried out at a temperature of over 1200° C., which is particularly energy-intensive and generates high greenhouse gas emissions. The clinker is generally ground then added with 5% gypsum, anhydrite and/or bassanite to produce Portland cement of the CEM1 type.

The term “D50” refers to the median diameter at which 50% (by volume or mass, preferably by volume) of the grains, particles, aggregates, or sediments are smaller than a given diameter. For example, if a sieve and sedimentometry analysis method indicates a D50=5.8 mm, then 50% of the particles in the sample (by volume or mass, preferably by volume) are larger than 5.8 mm and 50% are smaller than 5.8 mm. D50 is generally used to represent the particle size of a group of particles. D50 may be measured by any method known to the person skilled in the art. The D50 is preferably measured according to the ASTM D422-63 standard, according to the XP P 94-041 (1995), NF ISO 11277 (2020), NF EN ISO 17892-4 (2018) standard or according to the ASTM D6913-04 (2009) standard or in particular for fine particles standard ISO 13320:2020 (for example D10 or <65 μm).

The construction industry must evolve to optimize productivity while addressing societal and environmental challenges. In this context, research laboratories and manufacturers have proposed low-carbon construction binders containing reduced quantities of Portland clinker, or have attempted to replace Portland clinker with other calcined components that have a lower carbon footprint than Portland clinker. However, these mixtures still contain high quantities of Portland clinker and/or calcined components.

Indeed, even when construction binders do not contain Portland clinker, the latter still comprise almost 50% by weight of the construction binder in calcined components and have the disadvantage of not having a mechanical resistance equivalent to that of Portland cement of type CEM1 or CEM2.

However, it is becoming urgent to reduce the carbon footprint of the construction sector and to further limit the use of Portland cement or Portland clinker or to replace Portland cement/clinker with other components having a lower or even zero carbon footprint. To address this, the inventors have developed a construction binder comprising specific proportions of clinker, raw and calcined clay matrix which allow to reduce the amount of clinker and calcined clay matrix compared to construction binders containing clinker and/or calcined components while having a mechanical strength at 1 day of at least 5 MPa, preferably 10 MPa and a mechanical strength at 28 days of at least 30 MPa, preferably 40 MPa.

Thus, the invention relates in particular to a low-carbon construction binder comprising clinker, a calcined clay matrix, a raw clay matrix and a deflocculation agent. Furthermore, the mass ratio of the raw clay matrix to the calcined clay matrix is 0.2 to 7.

The construction binder according to the invention can be prepared extemporaneously or prepared on a production site then possibly stored and transported to the construction site.

The general and preferred characteristics of each of the constituents of the formulation according to the invention will be presented in detail.

### Raw Clay Matrix

The raw clay matrix may, for example, include at least one mineral species selected from: Illite, Kaolinite, Smectite, Vermiculite, Chlorite, Montmorillonites, Muscovite, Halloysite, Sepiolite, and Palygorskite.

Preferably, the raw clay matrix includes at least two types of clays selected from: Illite, Kaolinite, Smectite, Vermiculite, Chlorite, Montmorillonites, Muscovite, Halloysite, Sepiolite, Interstratified, Pyrophyllite, talcs, Serpentines and Palygorskite. This includes clays called interstratified clays which are complex combinations of several clays. Even more preferably, the raw clay matrix includes at least one mineral species selected from: Kaolinite, Illite, Smectite, Palygorskite, Sepiolite, Chlorite, Montmorillonites, and Vermiculite.

Table 1 below presents the chemical characteristics of these mineral species.

TABLE 1

| | Type of clay | Composition |
|---|---|---|
| Raw clay | Illite | (K, H₃O)(Al, Mg, Fe)₂(Si, Al)₄O₁₀[(OH)₂, (H₂O)] |
| matrix | Smectite | (Na, Ca)_{0.3}(Al, Mg)₂Si₄O₁₀(OH)₂, n H₂O |
| | Kaolinite | Al₂Si₂O₅(OH)₄ |
| | Bentonite | (Na, Ca)_{0.3}(Al, Mg)₂Si₄O₁₀(OH)₂ |
| | Vermiculite | (Mg, Ca)_{0.7}(Mg, Fe, Al)₆(Al, Si)₈O₂₂(OH)₄, n H₂O |
| | Chlorite | (Fe, Mg, Al)₆(Si, Al)₄O₁₀(OH)₈ |
| | Muscovite | KAl₂(AlSi₃O₁₀) (OH, F)₂ |
| | Halloysite | Al₂Si₂O₅(OH)₄ |
| | Sepiolite | Mg₄Si₆O₁₅(OH)₂, n H₂O |
| | Palygorskite | (Mg, Al, Fe³⁺)₅[Si₈O₂₀](OH)₂(OH2)₄ n H₂O |

Furthermore, the raw clay matrix may also comprise Montmorillonite and/or clays called interstratified clays which are complex combinations (at the atomic scale) of several clays.

The type of clay can be determined by methods known to the person skilled in the art. In particular, it will be possible to use X-ray diffractometry after specific preparation of the samples according to the method called oriented blade method (see Thiry et al.—2013—Technique de préparation des minéraux argileux en vue de l'analyse par diffraction des Rayons X et introduction à l'interprétation des diagrammes). For example, the following conditions can be used:
Equipment: Diffractometer, for example a BRUKER D8 ADVANCE (Bragg-Brentano geometry); for example with the following settings: Copper tube (λ Kα1≈1.54 Å) Generator power: 40 kV, 40 mA; Primary optics: 0.16° fixed slit; Secondary optics: 2.5° Soller slit; LynXeye XE-T detector
Acquisition parameters: Scanning from 4 to 70° 20; Scanning speed of 0.03° 20/second, Counting time: between 20 min and 60 min per pitch; Rotating sample.

The raw clay matrix may preferably correspond at least in part to an excavated clay soil, preferably an uncalcined excavated clay soil, such as a treated raw excavated clay soil. The raw clay matrix may advantageously have been treated, said treatment being selected from: grinding, sorting, sieving and/or drying. Preferably, the raw clay matrix used in the binder has been ground.

Preferably, a construction binder according to the invention comprises at least 5% by weight of raw clay matrix, more preferably at least 15% by weight of raw clay matrix. Indeed, the construction binder according to the invention has the advantage of being able to include a high amount of raw clay matrix without this altering the mechanical properties of the construction materials.

Furthermore, preferably, the construction binder according to the invention comprises at most 30% by weight of raw clay matrix, more preferably at most 25% by weight of raw clay matrix.

Thus, in particular, a construction binder according to the invention comprises between 5% and 30% by weight of raw clay matrix, preferably between 10% and 28% by weight or between 15% and 27% by weight of raw clay matrix, more preferably between 20% and 26% by weight of raw clay matrix, and even more preferably between 22% and 25% by weight of raw clay matrix.

Advantageously, the raw clay matrix may include crushed raw clay. Preferably, the raw clay matrix may have a D50 of less than or equal to 500 μm, preferably less than or equal to 250 μm, more preferably less than or equal to 100 μm or even more preferably less than or equal to 50 μm.

Furthermore, the raw clay matrix may have a D50 greater than or equal to 0.1 μm, preferably greater than or equal to 1 μm, more preferably greater than or equal to 10 μm or even more preferably greater than or equal to 20 μm, more preferably greater than 40 μm. This allows to limit the constraints on industrial production tools dedicated to grinding.

More preferably, the raw clay matrix may have a D50 comprised between 10 μm and 500 μm, preferably comprised between 15 μm and 250 μm, more preferably comprised between 20 μm and 150 μm or even more preferably comprised between 20 μm and 50 μm. The presence of a clay ground so as to reach such diameters can allow to improve the performance of the construction binder and the construction material according to the invention.

Advantageously, the raw clay matrix may include at least 2% by weight of loam particles, preferably at least 4% by weight, more preferably at least 6% by weight. For example, the raw clay matrix may include at most 50% by weight of loam particles, preferably at most 30% by weight, more preferably at most 20% by weight. For example, the raw clay matrix may include from 2% to 50% by weight of loam particles, preferably from 4% to 30% by weight, more preferably from 6% to 20% by weight. The loam particles are in particular particles having a diameter comprised between 2 μm and 63 μm.

The raw clay matrix may include at least 1% by weight of sand, preferably at least 2% by weight, more preferably at least 3% by weight. For example, the raw clay matrix may include at most 70% by weight of sand, preferably at most 50% by weight, more preferably at most 40% by weight. For example, the raw clay matrix may include from 1% to 70% by weight of sand particles, preferably from 2% to 50% by weight, more preferably from 3% to 40% by weight. The sand corresponds in particular to particles having a diameter comprised between 63 μm and 2 mm.

Preferably, the raw clay matrix includes clay contents in the mineralogical sense of the term of at least 10% by dry weight, more preferably at least 20% by dry weight, and even more preferably at least 30% by dry weight. However, a raw clay matrix including low clay contents in the mineralogical sense may be used. In particular, the raw clay matrix may correspond to fine clay-limestone or clay-silica/quartz particles including at least 50% by dry weight of limestone, silica or quartz, preferably at least 60%, more preferably at least 70% or even more preferably at least 80% by dry weight of limestone, silica or quartz.

### Calcined Clay Matrix

The calcined clay matrix may be a raw clay material which has previously undergone heat treatment, preferably at a temperature of at least 450° C. and at most 900° C., or in a flash calcination method at temperatures comprised between 800° C. and 1100° C.

Preferably, the calcined clay material is dehydroxylated to an amorphous material while the formation of high temperature aluminosilicate crystalline phases such as mullite is prevented.

The calcined clay matrix is preferably amorphous, and has a pozzolanic activity.

Furthermore, the calcined clay matrix may comprise at least 5% by weight of metal oxides, preferably at least 10% by weight of metal oxides, preferably at least 20% by weight of metal oxides, even more preferably at least 30% by weight of metal oxides. The calcined clay matrix may further comprise at most 70% by weight of metal oxides, preferably at most 60% by weight of metal oxides.

The calcined clay matrix can be formed with all the clay matrices already mentioned above. The calcined clay matrix can include, by way of non-limiting examples, at least one mineral species selected from: Metakaolin, Metaillite and/or Metamontmorillonite. Preferably, the clay matrix which has been calcined comprises kaolinite and/or illite. Thus, preferably, the calcined clay matrix corresponds to metakaolin or metaillite.

According to a preferred embodiment of the present invention, the calcined clay matrix is composed of metakaolin. Metakaolin is a material resulting from the calcination of kaolinite or minerals which are rich in kaolinite, for example which have a kaolinite content of at least 20% by weight, preferably at least 25% by weight, even more preferably at least 30% by weight.

Preferably the calcined clay matrix is a flashed clay matrix, such as for example metakaolin from flash calcination.

Alternatively, the calcined clay matrix may come from a natural pozzolanic rock, that is to say formed by volcanic basaltic projections or of a similar composition, or more generally from any substance which has “pozzolanic properties”, that is to say which has the ability to be combined, at room temperature and in the presence of water, with lime or portlandite to give very slightly soluble hydrates.

Preferably, a construction binder according to the invention comprises at least 5% by weight of calcined clay matrix, more preferably at least 15% by weight of calcined clay matrix. Indeed, the construction binder according to the invention has the advantage of being able to comprise a small amount of raw clay matrix without this altering the mechanical properties of the construction materials.

Furthermore, preferably, the construction binder according to the invention comprises at most 30% by weight of calcined clay matrix, more preferably at most 25% by weight of calcined clay matrix.

Thus, in particular, a construction binder according to the invention comprises between 5% and 30% by weight of calcined clay matrix, preferably between 10% and 25% by weight or between 10% and 20% by weight of calcined clay matrix, more preferably between 12.5% and 20% by weight of calcined clay matrix, and even more preferably between 12.5% and 15% by weight of calcined clay matrix.

### Preferred Mass Ratio

As illustrated in the examples, the applicant discovered that certain mass ratios between the raw clay matrix and the calcined clay matrix of the construction binder made it possible to obtain advantageous mechanical resistance properties at young age and at 28 days.

Advantageously, in a construction binder according to the present invention, the calcined clay matrix and the raw clay matrix are present in an amount such that the mass ratio by weight of the raw clay matrix to the calcined clay matrix is comprised between 0.33 and 3 (limits included). Indeed, as illustrated in the examples, such mass ratios allow to obtain a high Rc at 1d (for example greater than 7 MPa) while maintaining an Rc at 28d of at least 30 MPa.

### Deflocculation Agent

Many compounds can act as deflocculation agents and many are generally known to the person skilled in the art.

The presence of one or more deflocculation agent(s) can improve the performance of the material formed from the construction binder.

In the context of the invention, a construction binder may comprise an organic deflocculation agent, advantageously a deflocculating polymer. According to the present invention, an organic deflocculation agent includes at least one carbon atom and preferably at least one carbon-oxygen bond.

The deflocculating polymer may be a non-ionic surfactant such as a polyoxyethylene ether. The polyoxyethylene ether may for example be selected from: a lauryl poly(oxyethylene) ether.

The deflocculating polymer may also be an anionic agent such as an anionic surfactant. In particular, the anionic agent may be selected from: alkylaryl sulfonates, amino alcohols, carbonates, silicates, fatty acids, humates (for example sodium humates), carboxylic acids, lignosulfonates (for example sodium lignosulfonates), polyacrylates, phosphates or polyphosphates such as sodium hexametaphosphate, sodium tripolyphosphate, sodium orthophosphate, carboxymethylcelluloses and mixtures thereof.

The deflocculating polymer can also be a polyacrylate. It can then be selected, for example, from sodium polyacrylate and ammonium polyacrylate.

The deflocculating polymer may also be an amine selected for example from: 2-amino-2-methyl-1-propanol; mono-, di or tri ethanolamine, isopropanolamines (1-Amino-2-propanol, diisopropanolamine, triisopropanolamine) and N-alkyl ethanolamines.

Preferably, the deflocculating polymer is selected from: a lignosulphonate (for example sodium lignosulphonate), a polyacrylate, a humate and mixtures thereof.

Preferably, the deflocculating polymer is selected from: a lignosulphonate (for example sodium lignosulphonate), a polyacrylate, a humate, a polycarboxylate such as an ether polycarboxylate, and mixtures thereof.

More preferably, the deflocculating polymer includes a humate, a lignosulphonate and/or a polyacrylate.

The deflocculation agent can also be a silicate such as sodium silicate, sodium metasilicate or sodium trisilicate.

Alternatively, the deflocculation agent may be a mixture of compounds, such as a mixture including at least two compounds selected from: non-ionic surfactant, anionic agent, polyacrylate, amine and organophosphorus compound.

In particular, the deflocculation agent may be a mixture of sodium silicate and sodium carbonate.

The deflocculation agent is preferably in the form of a salt.

However, the invention cannot be limited to the deflocculating agents mentioned above; any type of deflocculating agent known to the person skilled in the art can be used instead of said deflocculating agents mentioned above.

The deflocculation agents usable according to the present invention may be in a solid form or a liquid form.

In particular, the deflocculation agent represents at least 0.05% by weight of the construction binder, preferably at least 0.1% by weight of the construction binder, preferably at least 0.25% by weight of the construction binder, more preferably at least 0.5% by weight of the construction binder, more preferably at least 0.5% by weight of the construction binder, even more preferably at least 0.8% by weight of the construction binder and for example at least 1% by weight of the construction binder.

Furthermore, the deflocculation agent represents at most 5% by weight of the construction binder, preferably at most 4% by weight of the construction binder, more preferably at most 3% by weight of the construction binder and even more preferably at most 2% by weight of the construction binder. Indeed, too high a concentration is not necessary to form a material with advantageous mechanical properties.

In particular, the deflocculation agent represents between 0.05% and 5% by weight of the construction binder, preferably between 0.1% and 4% by weight of the construction binder, more preferably between 0.25% and 3% by weight of the construction binder, even more preferably between 0.5% and 2% by weight of the construction binder and even more preferably between 0.8% and 2% by weight of the construction binder and even more preferably between 0.9% and 2% by weight of the construction binder.

### Precursor

The construction binder according to the invention may comprise a precursor. Without being limited by theory, the role of the precursor is to contribute to the mechanical strength of the construction material.

The precursor may comprise a source of carbonates in combination or not with silicates. In particular, the precursor may include sodium or potassium carbonate. Sodium or potassium carbonate can also be mixed with sodium or potassium silicate.

Preferably, the precursor may comprise a source of calcium carbonate. The source of calcium carbonate may correspond to a solid material composed mainly of carbonate minerals such as calcite or dolomite minerals.

As illustrative examples, the source of carbonate can be limestone, dolomite, chalk, aragonite or else vaterite.

Alternatively, the limestone can also be magnesium carbonate and or a mixture of magnesium carbonate and dolomite.

Preferably, the limestone is a natural limestone consisting primarily of calcium carbonate with various polymorphs, such as calcite and/or aragonite, but also containing some magnesium carbonate and/or dolomite. The limestone may also be a clayey limestone or a natural marl.

Furthermore, the precursor may comprise a siliceous filler or “quartz flour”. For example, the siliceous filler may comprise corpuscular silica and kaolinite.

The precursor may also comprise calcined schists, diatomite, phonolite, paper mill sludge ash, or crushed glass.

Additionally, the precursor may comprise at least 30% by weight of calcium oxide or at least 30% by weight of calcium carbonate.

Alternatively or in addition, the precursor may further comprise blast furnace slag, fly ash, incineration ash, volcanic ash, silica fumes, a limestone filler, for example a micronized limestone filler of known type, or a combination thereof.

The precursor may further have a specific particle size, for example a D50 characterizing the particle size for which 50% of the volume (or mass) of the precursor has a particle size less than 25 microns and 50% of the volume (or mass) of the precursor has a particle size greater than 5 microns. Alternatively, the precursor may have a specific particle size, for example an average particle size characterizing the average diameter of the particles between 5 microns and 50% of the volume (or mass) of the precursor has a particle size greater than 5 microns.

Alternatively, the precursor, such as calcium carbonate, may have a specific particle size, for example an average particle size characterizing the average particle diameter comprised between 0.1 micron and 100 microns, preferably comprised between 0.1 micron and 5 microns.

When the precursor is calcium carbonate, it can be made of vaterite.

The calcium carbonate may thus comprise at least 10% by weight of vaterite; or at least 20% by weight of vaterite; or at least 30% by weight of vaterite; or at least 40% by weight of vaterite; or at least 50% by weight of vaterite; or at least 60% by weight of vaterite; or at least 70% by weight of vaterite; or at least 80% by weight of vaterite; or at least 90% by weight of vaterite; or at least 95% by weight of vaterite; or at least 99% by weight of vaterite.

Vaterite, in the presence of water, forms aragonite. Vaterite can be obtained by any method known to the person skilled in the art.

In the invention, when the precursor is present, it may be present at a content of at least 1% by weight of the construction binder, preferably at a content of at least 10% by weight of the construction binder, even more preferably at a content of at least 15% by weight of the construction binder.

Furthermore, preferably, the construction binder according to the invention comprises at most 25% by weight of precursor, more preferably at most 20% by weight of precursor.

Thus, in particular, a construction binder according to the invention may comprise between 1% and 25% by weight of precursor, preferably between 10% and 25% by weight of precursor, more preferably between 15% and 20% by weight of precursor.

### Clinker

The construction binder according to the invention further comprises clinker.

Clinker is obtained by firing a mixture composed of approximately 80% limestone and 20% aluminosilicates. This firing, known as clinkerization, is generally carried out at a temperature of over 1200° C. As seen previously, clinker can also contain 5% gypsum. The role of gypsum is to provide sulfates that slow down the setting of the cement. Although gypsum is commonly used in addition to Portland clinker to form CEM 1, any other constituent that would provide sulfates and slow down the setting of the cement could be used in addition to or instead of gypsum, such as bassanite or anhydrite.

As a non-limiting example, the clinker may be “Portland” clinker. Portland clinker is made up of at least two-thirds by mass of calcium silicates (3CaO·SiO₂:C₃S and 2CaO·SiO₂:C₂S), the remaining part being made up of phases containing aluminum and iron, free lime (CaO) not exceeding 2%. The mass ratio (CaO)/(SiO₂) is generally greater than or equal to 2.

Preferably, a construction binder according to the invention comprises at least 35% by weight of clinker, more preferably at least 40% by weight of clinker.

Furthermore, preferably, the construction binder according to the invention comprises at most 60% by weight of clinker, more preferably at most 65% by weight of clinker.

Thus, in particular, a construction binder according to the invention comprises between 35% and 65% by weight of clinker, preferably between 40% and 60% by weight or between 45% and 60% by weight of clinker, more preferably between 45% and 55% by weight of clinker, and even more preferably between 45% and 50% by weight of clinker.

In a particular embodiment, a construction binder according to the invention comprises:
from 40% to 55% by weight of clinker,
from 15% to 25% by weight of a precursor,
from 5% to 15% by weight of a calcined clay matrix,
from 15% to 30% by weight of a raw clay matrix, and
from 0.05% to 2% by weight of a deflocculation agent;
   the mass ratio of the raw clay matrix to the raw clay matrix is from 0.2 to 7.

In another particular embodiment, a construction binder in accordance with the invention comprises:
39% by weight of clinker,
20% by weight of a precursor, preferably the precursor is a limestone filler,
10% by weight of a calcined clay matrix,
30% by weight of a raw clay matrix, and
1% by weight of a deflocculation agent.

In another particular embodiment, a construction binder in accordance with the invention comprises:
39% by weight of clinker,
20% by weight of a precursor, preferably the precursor is a limestone filler,
20% by weight of a calcined clay matrix,
20% by weight of a raw clay matrix, and
1% by weight of a deflocculation agent.

In another particular embodiment, a construction binder in accordance with the invention comprises:
39% by weight of clinker,
20% by weight of a precursor, preferably the precursor is a limestone filler,
25% by weight of a calcined clay matrix,
5% by weight of a raw clay matrix, and
1% by weight of a deflocculation agent.

In another particular embodiment, a construction binder according to the invention comprises:
50% by weight of clinker,
30% by weight of a calcined clay matrix,
20% by weight of a raw clay matrix, and
1% by weight of a deflocculation agent.

Thus, according to another aspect, the invention relates to a construction material formed from the low carbon construction binder according to the invention.

The low-carbon construction binder according to the invention allows in particular the manufacture of insulating construction material: from a construction binder according to the invention added with lightweight aggregates of the “plant or porous” type; lightweight concrete: from a construction binder according to the invention added with a foaming agent such as aluminum powder. This will allow air to be trapped in the material and improve its insulating properties; prefabrication elements: manufacture of concrete blocks or slabs in the factory from the construction binder according to the invention; and insulation modules.

### EXAMPLES

### Preparation of a Construction Binder:

In all the examples presented below, the construction binders according to the invention are prepared according to an identical protocol, namely that a dry premix is made between clinker, a raw clay matrix, a calcined clay matrix, a precursor (except for one of the examples which does not contain one) and a deflocculation agent in predetermined amounts, then water is added and the solution is mixed at low speed, that is to say substantially at 100 revolutions per minute for 90 seconds. Then, water and aggregates are added to the construction binder and mixed at low speed, that is to say substantially at 100 revolutions per minute for 45 seconds in order to obtain a construction material.

Alternatively, dry premixing can be achieved by first mixing the raw clay matrix, the calcined clay matrix and the deflocculation agent, then adding clinker and precursor (if present) in a second step.

The mass ratio of water to dry matter of the composition (also called construction binder) is adjusted to a value comprised between 0.4 and 0.6. In the examples, the construction material, a mortar, includes 25% by weight of binder, 75% by weight of sand; this mixture being supplemented with water for a mass ratio of water to dry matter of the binder adjusted to a value of 0.4.

The mortar based on the construction binder thus formed is then poured into two separate molds and left to mature at room temperature, that is to say approximately 20 degrees Celsius for twenty-four hours for the first mold and cured in water at 20° C. for twenty-eight days for the second mold.

Alternatively, the mortar may be poured into a mold then left to mature for less than twenty-four hours in a curing step, at room temperature, that is to say approximately 25 degrees Celsius or preferably under heat treatment. During this curing step, the mold may be sealed or the top layer of the building material may be covered with a curing compound to limit/prevent evaporation.

### Methodology for Measuring the Consistency of Construction Binders:

Once the constituents have been mixed, the consistency, hereinafter called rheology, of the freshly mixed mortars is determined by measuring the cone spreading value as described in standard NF EN 1015-3.

### Methodology for Measuring the Mechanical Properties of Construction Binders:

Once maturation is complete, the mechanical resistance is measured. The mechanical resistance of a construction binder is its compressive strength, such compression being measured according to standard NF EN 196-1, for a prism with a side of 40 millimeters and a length of 160 millimeters and is expressed in Mega Pascal (MPa).

Comparison of the Construction Binders According to the Invention with Known Construction Binders:

Table 2 below shows different types of known construction binders. The mass of the components relating to each formulation is expressed as a percentage of the total mass of the construction binder (dry weight).

TABLE 2

| | CEM2-A | LC3 | | |
|---|---|---|---|---|
| | (Reference) | (Reference) | REF1 | REF2 |
| CEM I (mixture of 95% ground | 80% | 50% | 50% | 50% |
| clinker and 5% ground | | | | |
| gypsum) | | | | |
| Precursor | 20% | 20% | 20% | 20% |
| | limestone | limestone | limestone | limestone |
| | filler | filler | filler | filler |
| Calcined clay matrix | 0% | 30% | 0% | 15% |
| Raw clay matrix | 0% | 0% | 30% | 15% |
| Deflocculation agent | 0% | 0% | 0% | 0% |
| Cone spreading rheology | 110 | 100 | 100 | 100 |
| (mm) | | | | |
| Compressive strength (MPa) | >15 | 10 | 3 | 5 |
| at 24 h | | | | |
| Compressive Strength (MPa) | >50 | 45 | 12 | 25 |
| at 28 days | | | | |
| Estimated Carbon Footprint | n.a | 15% | 25% | 20% |
| Reduction Compared to CEM | | | | |
| 2 A | | | | |
| Raw clay/calcined clay ratio | n.a | n.a | n.a | 1 |

Thus, Table 2 presents the mechanical resistances of known construction binders (Binder CEM2, LC3, REF1 and REF2) and not forming part of the invention, such as the construction binder of type CEM2 better known under the name of Portland limestone cement whose compressive strength is of the order of 50 MPa.

The LC3 formulation can be obtained by following the teachings of patent EP2429966. The LC3 type construction binder comprises 30% by weight of Metakaolin obtained by calcination of kaolin, 50% by weight of CEM 1 and 20% of a limestone filler. Thus the mechanical resistance relative to such a construction binder, of the order of 45 MPa, is close to the resistance of the CEM2 type construction binder.

Finally, the construction binders REF1 and REF2, obtained by following the teachings of patent application EP2429966, but by replacing all or part of the calcined clay matrix with a raw clay matrix. These tests show a sharp drop in mechanical strength (12 MPa) when the construction binder does not comprise (REF1) a calcined clay matrix and a higher mechanical strength (25 MPa) (REF2), but much lower than the references CEM2 and LC3, when the construction binder comprises a raw clay matrix and a calcined clay matrix in equivalent proportion. Thus, the absence of a calcined clay matrix or its presence in equivalent proportion with a raw clay matrix does not allow to obtain concrete with adequate mechanical properties.

Table 3 below shows different types of construction binders according to the invention (MTU01 to MTU05). The mass of the components relating to each formulation is expressed as a percentage of the total mass of the construction binder (dry weight). The construction binders presented below differ in particular in that the proportions of raw and calcined clay matrices are more or less significant, one of the examples of construction binders also comprises blast furnace slag as a precursor.

TABLE 3

| | MTU01 | MTU02 | MTU03 | MTU04 | MTU05 |
|---|---|---|---|---|---|
| CEM I (mixture of 95% ground | 39% | 39% | 39% | 32% | 49% |
| clinker and 5% ground gypsum) | | | | | |
| Precursor | 20% | 20% | 20% | 20% | 0% |
| | limestone | limestone | limestone | limestone | |
| | filler | filler | filler | filler | |
| Calcined clay matrix | 20% | 30% | 10% | 23.6% | 30% |
| Raw clay matrix | 20% | 10% | 30% | 23.6% | 20% |
| Deflocculation agent | 1% | 1% | 1% | 0.8% | 1% |
| Cone spreading rheology (mm) | 190 | 140 | 200 | 160 | 170 |
| Compressive strength (MPa) at | 10 | 10 | 8 | 7 | 11 |
| 24 h | | | | | |
| Compressive Strength (MPa) at | 42 | 47 | 40 | 30 | 41 |
| 28 days | | | | | |
| Estimated Carbon Footprint | 35% | 30% | 40% | 50% | 25% |
| Reduction Compared to CEM II | | | | | |
| A | | | | | |
| Raw clay/calcined clay ratio | 1 | 0.33 | 3 | 1 | 0.67 |

As shown in Table 3, the construction binders according to the invention have compressive strengths equivalent to or even higher than the compressive strengths obtained with concrete formed with CEM2 cement or LC3 type cement. Thus, the present invention allows to form a low-carbon construction binder, by further limiting the proportions of clinker and calcined clay matrix used. Thus, this allows to further reduce the carbon footprint and energy balance of these construction binders compared to low-carbon binders of the CEM2 and LC3 types to make it a construction material meeting the majority of the sector's needs. Finally, the construction binders according to the invention have the advantage of having an improved rheology compared to the reference construction binders, which comprise a calcined and/or raw clay matrix and a compressive strength at an early age which allows them to be used for the formation of any type of construction materials such as thin (less than 200 mm thick) or thick tiles, more generally for masonry work, of any nature in reinforced or prestressed concrete.

1. A construction binder comprising:
from 35% to 65% by weight of clinker,
from 5% to 30% by weight of a calcined clay matrix,
from 5% to 30% by weight of a raw clay matrix, and
from 0.05% to 5% by weight of a deflocculation agent;
wherein a mass ratio of the raw clay matrix to the calcined clay matrix is from 0.2 to 7.

2. The construction binder according to claim 1, said binder further comprising up to 25% by weight of a precursor.

3. The construction binder according to claim 2, the precursor comprising a source of calcium carbonate.

4. The construction binder according to claim 2, wherein the precursor is selected from: blast furnace slag, fly ash, silica fumes, natural or synthetic limestone filler, siliceous filler, diatomite.

5. The construction binder according to claim 3, wherein the calcium carbonate has a D50 between 0.1 μm and 5 μm.

6. The construction binder according to claim 3, wherein the calcium carbonate comprises vaterite.

7. The construction binder according to claim 1, wherein the deflocculation agent is an organic deflocculation agent.

8. The construction binder according to claim 1, wherein the raw clay matrix has a D50 substantially equal to 10 μm.

9. The construction binder according to claim 1, said binder comprising between 35% and 50% by weight of said clinker.

10. The construction binder according to claim 1, said binder comprising at least 10% and up to 30% by weight of raw clay matrix.

11. The construction binder according to claim 1, said binder comprising 30% by weight of raw clay matrix.

12. The construction binder according to claim 1, wherein the calcined clay matrix is metakaolin.

13. The construction binder according to claim 1, said binder comprising:
from 40% to 55% by weight of said clinker,
up to 25% by weight of a precursor,
from 5% to 15% by weight of said calcined clay matrix,
from 15% to 30% by weight of said raw clay matrix, and
from 0.05% to 2% by weight of said deflocculation agent;
wherein the mass ratio of the raw clay matrix to the calcined clay matrix is from 0.5 to 6.

14. The construction binder according to claim 1, said binder comprising:
39% by weight of said clinker,
20% by weight of a precursor,
10% by weight of said calcined clay matrix,
30% by weight of said raw clay matrix, and
1% by weight of said deflocculation agent.

15. The construction binder according to claim 1, said binder comprising:
39% by weight of said clinker,
20% by weight of a precursor,
20% by weight of said calcined clay matrix,
20% by weight of said raw clay matrix, and
1% by weight of said deflocculation agent.

16. The A construction material comprising the construction binder according to claim 1.
